(19) United States
(12) Patent Application Publication
(10) Pub. No.: US 2026/0221630 A1
(43) Pub. Date: Jul. 30, 2026

(54) BATTERY CELL

(71) Applicant: SK On Co., Ltd., Seoul (KR)

(72) Inventor: Jong Hun PARK, Daejeon (KR)

(21) Appl. No.: 19/456,973

(22) Filed: Jan. 22, 2026

(30) Foreign Application Priority Data
Jan. 24, 2025 (KR) 10-2025-0010854

(51) Int. Cl. H01M 50/578; H01M 50/119; H01M 50/179; H01M 50/533; H01M 50/552; H01M 50/566

(52) U.S. Cl. CPC H01M 50/578; H01M 50/119; H01M 50/179; H01M 50/533; H01M 50/552; H01M 50/566; H01M 2200/20

(57) ABSTRACT

The present disclosure relates to a battery cell, and a battery cell according to an embodiment includes: a case having a receiving space therein; an electrode assembly received in the receiving space; a current collecting member received in the receiving space and electrically connected to the electrode assembly; a through-hole formed at at least a portion of the case; and a terminal penetrating the case through the through-hole, wherein the terminal may include a first body portion of which at least a portion is exposed to an outside of the case, a second body portion of which at least a portion is in contact with at least a portion of the current collecting member, and a fragile portion that connects the first body portion and the second body portion and has a thickness that is less than the thickness of the second body portion.

### CROSS-REFERENCE TO RELATED PATENT APPLICATION

The present application claims priority under 35 U.S.C. § 119(a) to Korean patent application number 10-2025-0010854 filed on Jan. 24, 2025, in the Ministry of Intellectual Property, the entire disclosure of which is incorporated by reference herein.

### BACKGROUND OF THE INVENTION

### 1. Field

The present disclosure relates to a battery cell.

### 2. Description of the Related Art

With the issue of global warming becoming problematic in modern society, the demand for eco-friendly technologies as a countermeasure thereto is rapidly increasing. In particular, as technical demand for electric vehicles and ESS (Energy Storage Systems) increases, demand for secondary batteries, which are spotlighted as energy storage means, is explosively increasing, and in particular, demand for high-capacity secondary batteries is explosively increasing.

Meanwhile, due to fires or explosion accidents that have recently occurred during use of secondary batteries, social concern regarding safety in the use of secondary batteries is increasing. Based on such social concern, various attempts related to securing safety and stability of secondary batteries have recently been proposed.

In accordance with the demand for development of high-capacity secondary batteries, enlargement and densification of each battery cell constituting the secondary battery are being promoted. However, in such a case, when a safety accident occurs, more fatal safety problems than before may be caused.

### SUMMARY OF THE INVENTION

According to one aspect of the present disclosure, an electrode for a secondary battery and an electrode assembly for a secondary battery, which can rapidly and efficiently induce disconnection of an electrode terminal in the event of internal ignition so that occurrence of additional accident events can be prevented, can be provided.

According to another aspect of the present disclosure, a secondary battery having improved safety and stability can be provided.

Meanwhile, the present disclosure can be widely applied in green technology fields such as an Electric Vehicle, a Battery Charging Station, an Energy Storage System (ESS), and photovoltaics, wind power, and the like that use batteries. In addition, the present disclosure can be used for eco-friendly mobility including an electric vehicle and a hybrid vehicle for preventing climate change by suppressing air pollution and greenhouse gas emissions.

As a technical means to achieve the technical objects, a battery cell according to the present disclosure includes: a case having a receiving space therein; an electrode assembly received in the receiving space; a current collecting member received in the receiving space and electrically connected to the electrode assembly; a through-hole formed at at least a portion of the case; and a terminal penetrating the case through the through-hole, wherein the terminal may have a first body portion of which at least a portion is exposed to an outside of the case, a second body portion of which at least a portion is in contact with at least a portion of the current collecting member, and a fragile portion that connects the first body portion and the second body portion and has a thickness that is less than the thickness of the second body portion.

In a battery cell according to an embodiment, the case may comprise at least one of aluminum and iron.

In a battery cell according to an embodiment, the current collecting member may be a current collecting plate.

In a battery cell according to an embodiment, the terminal may comprise a first region located at the through-hole, a second region located outside the case, and a third region located in the receiving space, and an average cross-sectional area of the second region may be greater than a cross-sectional area of the through-hole, and an average cross-sectional area of the third region may be greater than the cross-sectional area of the through-hole.

In a battery cell according to an embodiment, the second body portion may be located at the third region, and an average cross-sectional area of the second body portion may be smaller than a cross-sectional area of the through-hole.

In a battery cell according to an embodiment, the second body portion may be welded to the current collecting member.

In a battery cell according to an embodiment, an average thickness of the fragile portion may be 5% to 50% of an average thickness of the second body portion.

In a battery cell according to an embodiment, when an internal pressure equal to or greater than a reference value is generated inside the case, the fragile portion may be disconnected.

In a battery cell according to an embodiment, the reference value may be 12 kgf/cm² to 23 kgf/cm².

In a battery cell according to an embodiment, as the fragile portion is disconnected, the first body portion and the second body portion may be completely separated.

In a battery cell according to an embodiment, the terminal may further comprise a connection portion connecting the first body portion and the second body portion and having a thickness thicker than a thickness of the fragile portion.

In a battery cell according to an embodiment, when an internal pressure equal to or greater than a reference value is generated inside the case, the fragile portion may be disconnected, and as the fragile portion is disconnected, the first body portion and the second body portion may be partially separated.

In a battery cell according to an embodiment, the reference value may be 12 kgf/cm² to 23 kgf/cm².

In a battery cell according to an embodiment, the electrode assembly may comprise a first electrode and a second electrode, the first electrode may comprise a first coating portion which is a region coated with a first electrode active material and a first non-coating portion which is a region other than the first coating portion, and the current collecting member may be in contact with the first non-coating portion.

In a battery cell according to an embodiment, the first electrode may be a positive electrode.

According to one aspect of the present disclosure, an electrode for a secondary battery and an electrode assembly for a secondary battery, which can rapidly and efficiently induce disconnection of an electrode terminal in the event of internal ignition so that occurrence of additional accident events can be prevented, can be provided.

According to another aspect of the present disclosure, a secondary battery having improved safety and stability can be provided.

Meanwhile, the present disclosure can be widely applied in green technology fields such as an Electric Vehicle, a Battery Charging Station, an Energy Storage System (ESS), and photovoltaics, wind power, and the like that use batteries. In addition, the present disclosure can be used for eco-friendly mobility including an electric vehicle and a hybrid vehicle for preventing climate change by suppressing air pollution and greenhouse gas emissions.

### BRIEF DESCRIPTION OF THE DRAWINGS

FIG. 1 is a diagram illustrating an example of a battery cell according to an

embodiment of the present disclosure.

FIG. 2 is a diagram illustrating an example of a cross-section at region A of FIG. 1.

FIG. 3 is a diagram illustrating an example for explaining a coupling relationship between a terminal and a case according to an embodiment of the present disclosure.

FIG. 4 is a diagram illustrating another example for explaining a coupling relationship between a terminal and a case according to an embodiment of the present disclosure.

FIG. 5 is a diagram illustrating a view of the terminal in a +Z direction of FIGS. 1 to 4 according to an embodiment of the present disclosure.

FIG. 6 is a diagram illustrating an example of a state in which a first body portion and a second body portion of the terminal are completely separated according to an embodiment of the present disclosure.

FIG. 7 is a diagram illustrating a view of the terminal in a +Z direction of FIGS. 1 to 4 according to another embodiment of the present disclosure.

FIG. 8 is a diagram illustrating an example of a state in which a first body portion and a second body portion of the terminal are partially separated according to an embodiment of the present disclosure.

### DETAILED DESCRIPTION

The embodiments described in the present specification may be modified into various other forms, and therefore, the technology according to an embodiment is not limited to the embodiments described below. Furthermore, throughout the specification, when any component “comprises,” “includes,” “contains,” or “has” another component, it means, unless otherwise stated, that the component does not exclude the presence of another component but may further include another component, and does not exclude elements, materials, or processes not additionally enumerated.

In the present specification, unless otherwise specified, that something is identical or uniform may mean that they are identical or uniform within an allowable margin of error. For example, that certain configurations or physical property measurement values are identical may include not only that the two objects being compared are completely the same but also that they are identical within the margin of error. Meanwhile, that a physical property measurement value is identical may mean that a difference in measured values between objects is less than about 5%, specifically less than 3%, and more specifically less than 1%.

In the present specification, that the angle formed by two objects is perpendicular, or that they are parallel or aligned with each other, may include not only geometrically perpendicular or parallel but also being within a slight margin of error.

In the present specification, numerical ranges include the lower limit and upper limit and all values within the range, increments logically derived from the form and width of the defined range, all values doubly limited, and all possible combinations of the upper and lower limits of numerical ranges limited in different forms.

In the present specification, unless otherwise defined, “about” may be considered as a value within 30%, 25%, 20%, 15%, 10%, or 5% of the specified value.

In the present specification, the use of terms such as “first,” “second,” and “third” before any component is merely to avoid confusion between the referenced components and is not related to order, importance, or hierarchical relationship among the components. For example, an invention including only a second component without a first component may also be implemented.

In the present specification, “X direction,” “Y direction,” and “Z direction” may be described based on a spatial orthogonal coordinate system defined by mutually orthogonal X-axis, Y-axis, and Z-axis. Unless otherwise stated, the Z direction (or third direction) may mean a height direction, the X direction (or first direction) may mean any one direction perpendicular to the height direction, and the Y direction (or second direction) may mean a direction perpendicular to both the Z direction and the X direction. However, the X direction, Y direction, and Z direction mentioned below are for explaining the present disclosure so that it can be clearly understood, and the directions may of course be defined differently depending on where the reference is placed.

In the present specification, the term “electrically connected” may mean, without limitation, all connection methods by which a plurality of objects can be connected so as to be electrically communicated with each other, and may be implemented in various aspects such that a plurality of objects to be mutually connected are directly connected to each other or are connected via a third object.

In the present specification, a configuration defined as “. . . portion” may, without limitation, mean one single component or a set of two or more identical or similar components having a commonality in terms of function, and the set of the components may be configured by hardware and/or software in an unrestricted combination.

In the present specification, the term “is disposed” may, without limitation, mean a positional relationship in which any one object can be positioned adjacent to another object. As a non-limiting example, it may mean coating any one object on another object, bonding any one object to another object via an adhesive material, attaching any one object by applying heat and/or pressure, simply positioning any one object within any space such that at least a portion of any one object can contact at least a portion of another object, or fixing and positioning any one object.

In the present specification, the term that any one object “covers” another object may, without limitation, mean a functional and structural relationship in which any one object is disposed at least adjacent to another object and can block or mitigate any external factor that may be applied to the other object.

In the present specification, the term “secondary battery” may mean a battery that generates electrical energy by an oxidation-reduction reaction when ions, specifically cations such as lithium ions, are inserted into and desorbed from a positive electrode and a negative electrode. Specifically, the “secondary battery” may mean any one of a lithium cobalt battery, a lithium high-nickel battery, a lithium iron phosphate battery, a lithium ion battery, a lithium polymer battery, a lithium sulfur battery, a nickel metal hydride battery, a nickel cadmium battery, a sodium battery, and an all-solid-state battery. By way of example, the term “secondary battery” used in the present specification may mean a lithium ion secondary battery, but is not necessarily limited thereto.

In the present specification, the term “battery assembly” may be a concept collectively referring to a battery module or a battery pack. Therefore, a battery assembly according to the present disclosure may not only mean a battery module, but may also mean a battery pack that omits a battery module structure and receives a plurality of battery cells, such as Cell to Pack (CTP).

In the present specification, the term “battery cell” may mean a basic unit of the above-described secondary battery, which includes, as main components, an electrode assembly, an electrolyte, and an exterior material and is capable of charging and discharging electrical energy.

Hereinafter, the present disclosure will be described in detail. However, this is merely by way of example, and the present disclosure is not limited to the specific embodiments described as examples.

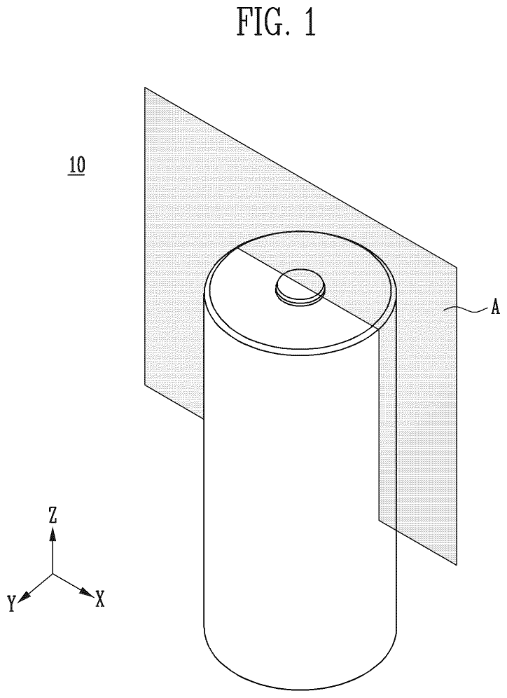

FIG. 1 is a diagram illustrating an example of a battery cell according to an embodiment of the present disclosure.

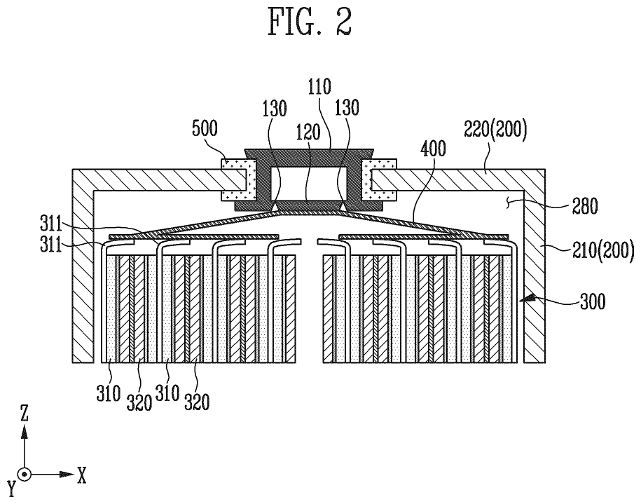

FIG. 2 is a diagram illustrating an example of a cross-section at region A of FIG. 1.

The battery cell 10 according to an embodiment of the present disclosure includes: a case 200 having a receiving space 280 therein; an electrode assembly 300 received in the receiving space 280; a current collecting member 400 received in the receiving space 280 and electrically connected to the electrode assembly 300; a through-hole 230 formed at at least a portion of the case 200; and a terminal 100 penetrating the case 200 through the through-hole 230, wherein the terminal 100 may include a first body portion 110 of which at least a portion is exposed outside the case 200, a second body portion 120 of which at least a portion is in contact with at least a portion of the current collecting member 400, and a fragile portion 130 that connects the first body portion 110 and the second body portion 120 and has a thickness that is less than the thickness of the second body portion 120.

In one embodiment, the battery cell 10 may include a case 200 in which a through-hole 230 is formed at at least a portion, an electrode assembly 300, a current collecting member 400, and a terminal 100. The electrode assembly 300 and the current collecting member 400 may be received in the receiving space 280 inside the case 200. The terminal 100 may be included in a form penetrating the case 200 through the through-hole 230, and at least a portion thereof may be located outside the case 200, and at least a portion of the remaining portion thereof may be located in the receiving space 280.

In one embodiment, the case 200 may form an exterior shape of the battery cell 10. FIG. 1 illustrates a cylindrical can-type battery cell 10; however, the battery cell 10 of the present disclosure is not necessarily limited to a cylindrical battery cell 10, and the battery cell 10 of the present disclosure may have various shapes or forms as long as the defined matters of the present disclosure are not impaired. For example, the battery cell 10 may be a prismatic battery cell. Furthermore, as required, the battery cell 10 may be a pouch-type battery cell or a coin-type battery cell.

In one embodiment, the case 200 may include a sidewall portion 210 having a receiving space therein, a closed end portion 220 formed at one end of the sidewall portion 210, and an opening provided at the other end of the sidewall portion 210.

In one embodiment, for example based on what is illustrated in FIG. 1, the sidewall portion 210 may be formed in a shape capable of having a receiving space of a shape extending in one direction (a cylindrical shape in FIG. 1).

In one embodiment, the closed end portion 220 may be formed at one end of the sidewall portion 210. In a specific embodiment, the closed end portion 220 may be formed at one end of the sidewall portion 210 in a direction substantially perpendicular to a direction in which the sidewall portion 210 extends so as to seal one end of the sidewall portion 210. Here, the one end may mean any one of both ends of the sidewall portion 210 when viewed based on the extending direction of the sidewall portion 210 having a shape extending in one direction.

In one embodiment, the closed end portion 220 may be formed to extend from one end of the sidewall portion 210. That is, in such a case, the closed end portion 220 may be integrally formed with the sidewall portion 210.

Conversely, in one embodiment, the closed end portion 220 may be formed at one end of the sidewall portion 210 but may be formed separately from the sidewall portion 210. In such an embodiment, the closed end portion 220 may be configured to be separable, at least in part, from the sidewall portion 210.

In one embodiment, the opening may be provided at the other end of the sidewall portion 210. Here, the other end may mean the other one of both ends of the sidewall portion 210, except for the one end, when viewed based on the extending direction of the sidewall portion 210 having a shape extending in one direction.

In one embodiment, the opening may be communicated with the receiving space. Therefore, the electrode assembly 300 and the current collecting member 400 may be received inside the case 200 through the opening.

In one embodiment, the battery cell 10 may further include a cap plate (not shown). Meanwhile, the cap plate (not shown) may also be understood as an additional component constituting the case 200.

In one embodiment, the opening may be sealed by being covered with the cap plate (not shown). When the opening is covered with the cap plate (not shown), the receiving space 280 may be sealed from the outside by the sidewall portion 210, the closed end portion 220, and the cap plate (not shown).

In one embodiment, the opening may be a space communicated with the receiving space 280 and may mean a planar space of a circular, elliptical, or oblong shape that contacts the one end. Conversely, in one embodiment, the opening may mean a planar space that is a polygon such as a quadrilateral, a triangle, or a pentagon, or includes or further includes at least a portion of these, which contacts the one end depending on the shape of the sidewall portion 210.

In one embodiment, the cap plate (not shown) may cover the opening. As described above, the opening may be sealed by being covered with the cap plate (not shown).

In one embodiment, the cap plate (not shown) may be welded to the case 200. In an exemplary embodiment, the welding may not be particularly limited as long as it corresponds to a welding method that can be used for joining metallic materials.

In one embodiment, the cap plate (not shown) may be beading-coupled to the case 200. In an exemplary embodiment, the beading coupling may be performed by beading at least a portion of a region of the sidewall portion 210 along a circumference thereof, the region including the other end adjacent to the opening, disposing the cap plate (not shown) on the beaded region such that the cap plate (not shown) covers the opening, and then crimping the region of the sidewall portion 210 including the other end; however, the present disclosure is not limited thereto.

In one embodiment, the case 200 may comprise at least one of aluminum and iron.

In one embodiment, the case 200 may comprise aluminum (Al) and/or iron (Fe) as a material. Meanwhile, in an exemplary embodiment, the case 200 may further comprise a carbon steel material. For example, the case 200 may include, without limitation, at least one of ultra-low carbon steel, low carbon steel, medium carbon steel, or high carbon steel materials. In a specific embodiment, the case 200 may comprise a carbon steel material having a carbon content of approximately 0.8 wt % or less.

In one embodiment, the case 200 may also be formed of a material in which the aluminum and/or carbon steel material is plated. The plating treatment is for preventing corrosion of the case 200, and any known technology may be employed without limitation as long as it corresponds to plating of a metal for corrosion prevention.

As the case 200 comprises the material as described above, the case 200 may exhibit excellent mechanical rigidity.

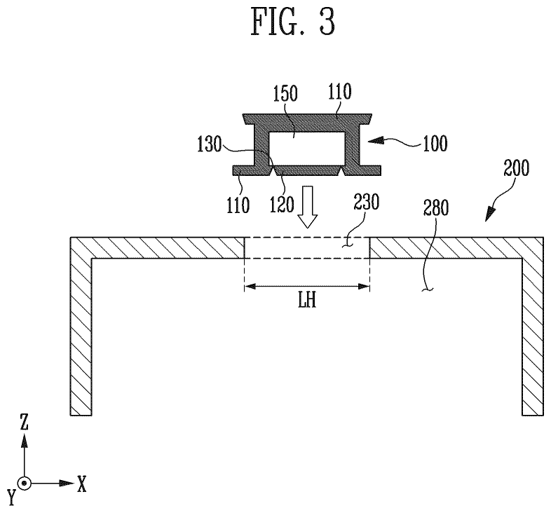

Referring also to FIG. 3 to be described later, in one embodiment, a through-hole 230 may be formed at at least a portion of the case 200.

In one embodiment, at least a portion of the case 200 may be provided with the through-hole 230, which is a region penetrating the case 200. The through-hole 230 may be communicated with the receiving space 280. The through-hole 230 may mean a region in which the terminal 100, to be described later, is located so that the terminal 100 can electrically communicate the outside of the battery cell 10 with the inside of the case 200.

In one embodiment, the through-hole 230 may be formed at a position facing the opening. That is, in such an embodiment, the through-hole 230 may be formed at at least a portion of the closed end portion 220. In an exemplary embodiment, the through-hole 230 may be formed at a center of the closed end portion 220.

Conversely, in one embodiment, the through-hole 230 may be formed at at least a portion of the cap plate (not shown). In such an embodiment, the through-hole 230 may be formed at a center of the cap plate (not shown).

FIGS. 1 and 2 and drawings to be described later illustrate an example in which the through-hole 230 is formed at the closed end portion 220. In such an embodiment, the cap plate (not shown) may not include a through-hole 230 for insertion of the terminal 100. In such an embodiment, the cap plate (not shown) may include a filling portion for injecting an electrolyte or a notched portion for venting gas.

Meanwhile, an insulating gasket 500 may be located at the through-hole 230. As the terminal 100 penetrates the case 200 through the through-hole 230, the insulating gasket 500 may be positioned between the case 200 and the terminal 100 so that the terminal 100 does not directly contact the case 200. The insulating gasket 500 may comprise an electrically insulating material for this purpose.

Referring to FIG. 2, in one embodiment, the electrode assembly 300 may be received in the receiving space 280 of the case 200. In a specific embodiment, the electrode assembly 300 may be received in a wound form in the receiving space of the case 200.

As will be described later, in one embodiment, the electrode assembly 300 may include an electrode comprising a cathode and an anode and a separator. The electrode assembly 300 having such a configuration may produce electrical energy through discharge or may store electrical energy supplied from an outside through charging.

Detailed configurations of the electrode assembly 300 will be described later.

Referring again to FIG. 2, in one embodiment, the current collecting member 400 may be received in the receiving space 280 of the case 200 and may be electrically connected to the electrode assembly 300.

In one embodiment, the current collecting member 400 may provide a path through which electrical energy produced from the electrode assembly 300 is delivered to an outside or electrical energy supplied from the outside is delivered to the electrode assembly 300.

In one embodiment, the current collecting member 400 may comprise a conductive material such as aluminum, copper, gold, silver, stainless steel, nickel, titanium or an alloy thereof, or a conductive polymer. Alternatively, in one embodiment, the current collecting member 400 may comprise aluminum, copper, or stainless steel whose surface is treated with carbon, nickel, titanium, or silver.

In one embodiment, as will be described later, when the electrode connected to the current collecting member 400, that is, the first electrode, is a positive electrode, the current collecting member 400 may comprise aluminum. In such a case, the current collecting plate may include only aluminum as its material, or may include aluminum to which coating, doping, or other treatments are applied, or may include an aluminum alloy.

In one embodiment, the current collecting member 400 may be a current collector plate.

In one embodiment, the current collector plate may be formed in a plate shape having a predetermined thickness. In an exemplary embodiment, the plate-shaped current collector plate may be formed in a plate shape having a circular, elliptical, oblong, or a shape including at least a portion thereof as a cross-section.

The current collector plate may contact the non-coating portion of the electrode as will be described later. In a specific embodiment, the current collector plate may be welded so as to be directly electrically connected to the non-coating portion of the electrode.

Meanwhile, in another embodiment, the current collecting member 400 may be a current collecting lead. When the current collecting member 400 is a current collecting lead, the current collecting lead may extend in one direction and may be formed in a shape having a predetermined thickness, and one end thereof may be connected to the terminal 100, and the other end thereof may be connected to the electrode assembly 300.

In one embodiment, the terminal 100 may be electrically connected to an external device that supplies electrical energy or requires electrical energy, and at the same time may electrically communicate the inside and the outside of the battery cell 10 by being electrically connected to a power generation element (such as the electrode assembly) or a current collecting element (such as the current collecting member) received inside the case 200. With such a configuration, the terminal 100 may function as an external terminal of the battery cell 10.

Referring again to FIG. 2, in one embodiment, the terminal 100 may include a first body portion 110 of which at least a portion is exposed outside the case 200, a second body portion 120 of which at least a portion is in contact with at least a portion of the current collecting member 400, and a fragile portion 130 connecting the first body portion 110 and the second body portion 120 and having a thickness thinner than a thickness of the second body portion 120.

In one embodiment, the terminal 100 may include the first body portion 110, the second body portion 120, and the fragile portion 130. As described above, the first body portion 110 may mean a configuration in which at least a portion thereof is exposed outside the case 200 in the terminal 100, the second body portion 120 may mean a configuration in which at least a portion thereof is in contact with at least a portion of the current collecting member 400 in the terminal 100, and the fragile portion 130 may mean a portion of a configuration connecting the first body portion 110 and the second body portion 120.

In one embodiment, when any external force is applied to the terminal 100, the fragile portion 130 may be disconnected, thereby separating the first body portion 110 and the second body portion 120. Therefore, in one embodiment, the first body portion 110 and the second body portion 120 may be defined as one configuration and another configuration that may be completely or partially separated when an external force is applied to the terminal 100. In such an embodiment, the fragile portion 130 may be defined as a configuration that connects the first body portion 110 and the second body portion 120 and that may completely or partially separate the first body portion 110 and the second body portion 120 by being disconnected when an external force is applied to the terminal 100.

Meanwhile, in one embodiment, the terminal 100 may further include a space portion 150. The space portion 150 may mean an empty space in the terminal 100 that is not spatially occupied by any object.

Based on what is illustrated in FIG. 2, for example, in one embodiment, the space portion 150 may be formed in a hollow shape inside the terminal 100 and may not be spatially communicated with the outside. That is, in one embodiment, the space portion 150 may be a configuration that is sealed by at least one configuration of the terminal 100.

In one embodiment, as illustrated in FIG. 2, the space portion 150 may be in contact with all of the first body portion 110, the second body portion 120, and the fragile portion 130. In a specific embodiment, the space portion 150 may be surrounded by the first body portion 110, the second body portion 120, and the fragile portion 130 and may be sealed from the outside. With such a configuration, through the configuration of the space portion 150, the fragile portion 130 may be disconnected more effectively when an external force is applied to the terminal 100, as will be described with reference to drawings to be described later.

In another embodiment, the space portion 150 may be spatially communicated with the outside. That is, in such an embodiment, the space portion 150 may not be sealed by at least one configuration of the terminal 100, and at least a portion thereof may be communicated with the outside.

FIG. 3 is a diagram illustrating an example for explaining a coupling relationship between a terminal and a case according to an embodiment of the present disclosure.

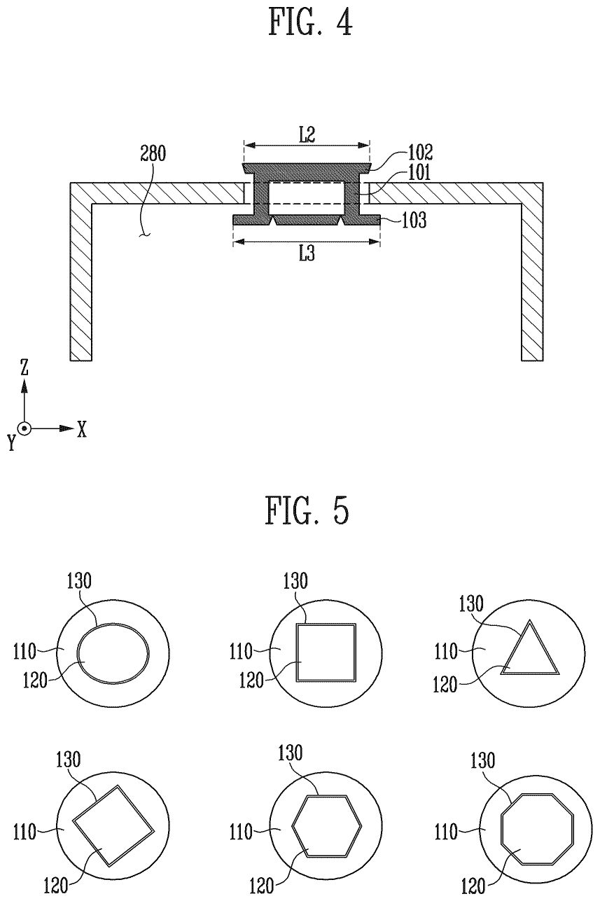

FIG. 4 is a diagram illustrating another example for explaining a coupling relationship between a terminal and a case according to an embodiment of the present disclosure.

Referring to FIGS. 3 and 4, in one embodiment, the terminal 100 may include a first region 101 located at the through-hole 230, a second region 102 located outside the case 200, and a third region 103 located in the receiving space 280, and an average cross-sectional area of the second region 102 may be greater than a cross-sectional area of the through-hole 230, and an average cross-sectional area of the third region 103 may be greater than the cross-sectional area of the through-hole 230.

In one embodiment, the terminal 100 may include the first region 101 located at the through-hole 230, the second region 102 located outside the case 200, and the third region 103 located in the receiving space 280.

Unlike the configurations of the first body portion 110, the second body portion 120, and the fragile portion 130 described above with reference to FIGS. 1 and 2, the first region 101, the second region 102, and the third region 103 may be virtual division regions defined according to locations of the terminal 100 in a state in which the terminal 100 is coupled with other components inside the battery cell 10. In such an embodiment, the terminal 100 may be physically divided into the first body portion 110, the second body portion 120, and the fragile portion 130, and at the same time may be virtually divided into the first region 101, the second region 102, and the third region 103.

FIG. 4 illustrates a positional relationship between the terminal 100 and the case 200 in a coupled state. In such an embodiment, the first region 101 is located at the through-hole 230, and the second region 102 is located, for example, in the +Z direction based on what is illustrated in FIG. 4, and is positioned so as to be exposed outside the case 200, and the third region 103 is located, for example, in the −Z direction based on what is illustrated in FIG. 4, and is positioned in the receiving space 280 inside the case 200. Meanwhile, referring to FIGS. 3 and 4, the first body portion 110 may be included in all of the first region 101, the second region 102, and the third region 103, and the second body portion 120 and the fragile portion 130 may be included only in the third region 103; however, the present disclosure is not limited thereto, and various modes of division and inclusion may be implemented as needed.

In the present specification, the term “cross-section” may mean a surface observed when a selected region is cut in a direction perpendicular to an extending direction of the terminal 100, and the term “cross-sectional area” may mean an area of the surface. That is, for example based on what is illustrated in FIG. 4, the cross-section may mean a surface observed when a selected region is cut in a direction perpendicular to the Z direction of FIG. 4, and the cross-sectional area may mean an area of the surface. In a specific embodiment, the cross-section may mean a surface observed when a selected region is cut along a plane parallel to the XY plane of FIG. 4.

Meanwhile, the average cross-sectional area of the second region 102 or the average cross-sectional area of the third region 103 may mean an average value of cross-sectional areas observed and measured from the second region 102 or the third region 103 of the terminal 100 in the manner described above. For example, referring to FIG. 4, the second region 102 and the third region 103 may have different cross-sectional areas along the Z direction. An average value of such differing cross-sectional areas may be defined as the average cross-sectional area.

In the embodiment described above, the terminal 100 may have a substantially “H” shaped configuration. For example, based on what is illustrated in FIG. 4, the shape of a surface observed when the terminal 100 is cut along a plane parallel to the XZ plane of FIG. 4 may be substantially “H” shaped. Therefore, in the terminal 100, an average cross-section of a region located at the through-hole 230 may be the narrowest, and the average cross-sections of a region exposed outside the case 200 and of a region located in the receiving space 280 may be wider than that. Meanwhile, as described above, the average cross-section of the region exposed outside the case 200 and the average cross-section of the region located in the receiving space 280 may be wider than the cross-section of the through-hole 230.

Meanwhile, referring again to FIGS. 3 and 4, the second region 102 and the third region 103 may have region average lengths L2 and L3 defined, and the through-hole may have a region length LH defined. Here, the region average length may mean an average value of distance values in a direction perpendicular to the extending direction of the terminal 100 according to the extending direction in each region. For example, referring to FIGS. 3 and 4, it may mean a distance in the X direction of each region, or an average distance in the X direction.

In one embodiment, as described above, when the case 200 has a cylindrical shape, the through-hole 230 and the terminal 100 may also include circular cross-sections, and in this case, the region length or the region average length may mean a cross-sectional diameter or an average cross-sectional diameter in each region. Alternatively, as described above, when the case 200 has a prismatic shape, for example, a rectangular column shape, the through-hole 230 and the terminal 100 may include rectangular cross-sections, and in this case, the region length or the region average length may mean a cross-sectional edge length or an average cross-sectional edge length in each region.

In the embodiment described above, the region length or the region average length may satisfy the following Equations 1-1 and 1-2.

$$L 2 > LH \qquad [ Equations 1 - 1 ]$$

$$L 3 > LH \qquad [ Equations 1 - 2 ]$$

Referring again to FIGS. 3 and 4, in one embodiment, the second body portion 120 may be located in the third region 103, and an average cross-sectional area of the second body portion 120 may be smaller than a cross-sectional area of the through-hole 230.

As described above, the third region 103 may mean a region located in the receiving space 280 inside the case 200 in a state in which the terminal 100 is coupled with the case 200. In such an embodiment, the second body portion 120 may be located in the third region 103, that is, the second body portion 120 may be located in the receiving space 280 inside the case 200.

Meanwhile, in one embodiment, the average cross-sectional area of the second body portion 120 may be smaller than the cross-sectional area of the through-hole 230. Here, the definitions of the cross-sectional area or the average cross-sectional area may be applied as described above.

Meanwhile, referring again to FIGS. 3 and 4, a region average length LB may also be defined for the second body portion 120, and the definition of the region average length may be applied as described above. In such an embodiment, a region average length of the second body portion 120 and the third region 103 and a region length of the through-hole 230 may satisfy the following Equation 2.

$$LB < LH < L 3 \qquad [ Equation 2 ]$$

In such an embodiment, as described above, the first body portion 110, the second body portion 120, and the fragile portion 130 may all be located in the third region 103. In such an embodiment, the first body portion 110 may be configured to surround an outer periphery of the second body portion 120, and may be mutually connected by the sidewall portion 210.

In such an embodiment, an average cross-sectional area of the third region 103 may be greater than the cross-sectional area of the through-hole 230 as described above, and the first body portion 110 may be located at an outermost portion in the third region 103, and the second body portion 120 may be located in the third region 103 such that its average cross-sectional area is smaller than the cross-sectional area of the through-hole 230.

Therefore, when an internal pressure is generated inside the battery cell 10, that is, inside the case 200, as will be described later, the terminal 100 may receive a force, for example, in the +Z direction based on what is illustrated in FIGS. 2 to 4. According to the application of such a force, a portion of the first body portion 110 located at the outermost portion of the third region 103 may be configured to overlap with the case 200 in the +Z direction, and the portion of the first body portion 110 overlapping with the case 200 in the +Z direction may serve as a kind of catching step.

Meanwhile, the second body portion 120 surrounded by the first body portion 110 inside the third region 103 is connected by the fragile portion 130, and as described above, may contact the current collecting member 400 received in the receiving space 280 and, as will be described later, may be welded to the current collecting member 400. As the current collecting member 400 does not undergo displacement, or undergoes only a negligible amount of displacement, even when an internal pressure is generated inside the case 200, the current collecting member 400 may apply a force in the −Z direction so that displacement of the second body portion 120 is suppressed when internal pressure is generated inside the case 200.

Accordingly, in such an embodiment, when internal pressure is generated inside the case 200, directions of forces respectively acting on the first body portion 110 and the second body portion 120 located in the third region 103 may differ, and as a result, due to the configuration in which the first body portion 110 and the second body portion 120 are connected by the fragile portion 130 having relatively weak physical strength, the fragile portion 130 may be disconnected, and the first body portion 110 and the second body portion 120 may be completely or partially separated.

Meanwhile, referring again to FIG. 2, in one embodiment, the second body portion 120 may be welded to the current collecting member 400. That is, at least a portion of the second body portion 120 may contact at least a portion of the current collecting member 400, and the contact may be fixed by welding.

In an exemplary embodiment, the welding may correspond to a welding method that can be used for joining metal materials, and the method is not particularly limited.

Meanwhile, in one embodiment, the current collecting member 400 may contact only the second body portion 120 and may not contact the first body portion 110.

As described above, by welding the second body portion 120 and the current collecting member 400, the two may be electrically connected to each other, and the second body portion 120 may be coupled in a state fixed to the current collecting member 400. Therefore, when internal pressure is generated inside the case 200, a force in a direction opposite to that of the first body portion 110 may be applied to the second body portion 120 by the current collecting member 400, which does not undergo displacement or undergoes only a negligible amount of displacement.

FIG. 5 is a diagram illustrating a view of the terminal in a +Z direction of FIGS. 1 to 4 according to an embodiment of the present disclosure.

In one embodiment, the terminal 100 may include a fragile portion 130, and the fragile portion 130 may connect the first body portion 110 and the second body portion 120, and may have a thickness thinner than a thickness of the second body portion 120.

In one embodiment, the fragile portion 130 may be configured to be vulnerable to any physical external force. In one embodiment, the fragile portion 130 may connect the first body portion 110 and the second body portion 120, and may be configured such that when any external force is applied, the fragile portion 130 is broken so that the first body portion 110 and the second body portion 120 may be easily separated. Meanwhile, the external force may mean a force applied such that, as described above, when internal pressure is generated in the case 200, forces in different directions are generated respectively on the first body portion 110 and the second body portion 120.

In one embodiment, an average thickness of the fragile portion 130 may be 5% to 50% of an average thickness of the second body portion 120.

In a specific embodiment, the average thickness of the fragile portion 130 may be 7% or more, 9% or more, 10% or more, 12% or more, 15% or more, 17% or more, 19% or more, 20% or more, 21% or more, or 22% or more of the average thickness of the second body portion 120, or may be 48% or less, 46% or less, 45% or less, 42% or less, 40% or less, 38% or less, 36% or less, 35% or less, or 32% or less.

In one embodiment, the thickness may mean a thickness in the Z direction based on what is illustrated in FIGS. 2 to 4. Meanwhile, the average thickness of the fragile portion 130 may mean an average value of an overall thickness of the fragile portion 130, and the average thickness of the second body portion 120 may also be defined in the same manner.

When the average thickness of the fragile portion 130 is less than the numerical range described above, the fragile portion 130 may be easily broken or disconnected even by a small external force, thereby degrading mechanical strength of the battery cell 10 itself. When the average thickness of the fragile portion 130 exceeds the numerical range described above, the fragile portion 130 may not be easily broken by external force, making it difficult to achieve disconnection and separation of the terminal 100 due to internal pressure generation as intended in the present disclosure.

Meanwhile, FIG. 5 illustrates a shape observed at a lower portion of the terminal 100 according to an embodiment of the present disclosure, particularly in the third region 103. As described above, in the third region 103, the second body portion 120 may be surrounded by the first body portion 110, and the first body portion 110 and the second body portion 120 may be connected by the fragile portion 130.

In such an embodiment, the fragile portion 130 may have a closed-curve cross-section. In such an embodiment, the first body portion 110 may completely surround the second body portion 120 via the fragile portion 130.

Referring to what is illustrated in FIG. 5, the cross-sectional shape of the fragile portion 130 may have various closed-curve shapes as needed. For example, the cross-sectional shape may be circular, elliptical, or oblong, or may have a polygonal shape such as square, rectangle, parallelogram, trapezoid, diamond, triangle, pentagon, hexagon, heptagon, or octagon, or may include at least a portion thereof. In a specific embodiment, the cross-sectional shape of the fragile portion 130 may include at least one of a circular shape, an elliptical shape, or an oblong shape, but is not necessarily limited thereto.

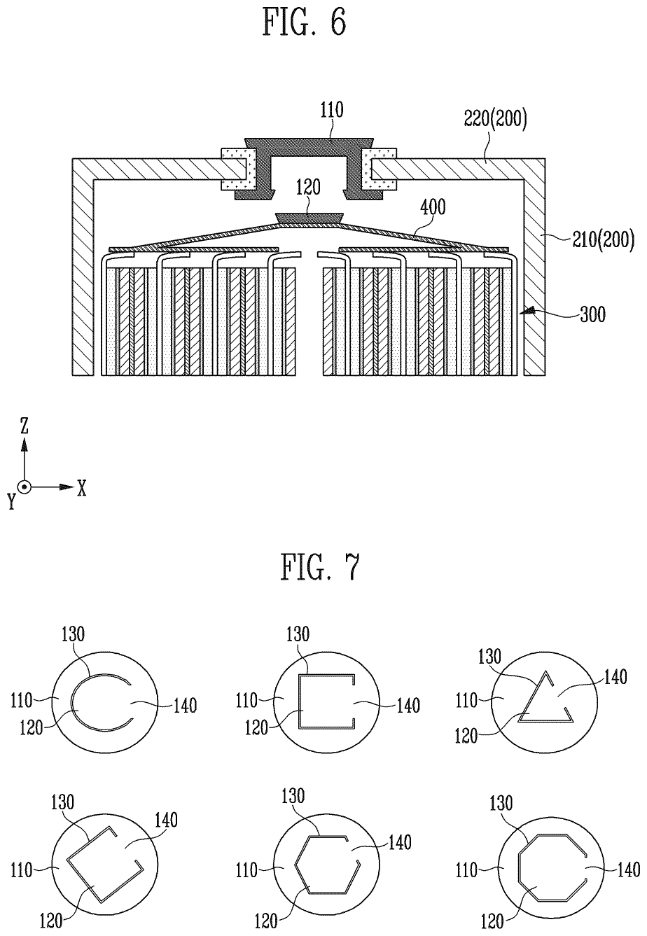

FIG. 6 is a diagram illustrating an example of a state in which a first body portion and a second body portion of the terminal are completely separated according to an embodiment of the present disclosure.

Referring to FIG. 6 together with the drawings described above, in one embodiment, according to the embodiment as described above, when an internal pressure equal to or higher than a reference value is generated inside the case 200, the fragile portion 130 may be disconnected.

Meanwhile, in a specific embodiment, when an internal pressure equal to or higher than the reference value is generated inside the case 200, the fragile portion 130 may be entirely disconnected.

As described above, when any component inside the battery cell 10 is degraded or damaged for any reason, or when a connection or coupling structure between internal components is degraded or damaged, an internal short circuit between the positive electrode and the negative electrode, or between other conductive components received inside the battery cell 10, may occur, resulting in internal ignition. Due to gas generated by such ignition, an internal pressure of the battery cell 10 may increase compared to a normal state. This may mean that an internal pressure is generated inside the case 200.

Meanwhile, as described above, when such internal pressure is generated inside the case 200, according to the embodiment described above, forces may be applied to the first body portion 110 and the second body portion 120 in different directions. Specifically, the first body portion 110 may receive a force in the +Z direction, for example, based on FIGS. 2 to 4, due to the internal pressure, and the second body portion 120, which is welded to the current collecting member 400, may receive a force in the −Z direction due to the welding coupling. As forces in different directions are thus applied to the first body portion 110 and the second body portion 120, the fragile portion 130, which is a physically weak portion, may be disconnected. At this time, the fragile portion 130 may be configured to be disconnected when an internal pressure equal to or higher than the reference value is generated inside the case 200.

In one embodiment, the reference value may be 12 kgf/cm² to 23 kgf/cm². In a specific embodiment, the reference value may be 13 kgf/cm² to 22 kgf/cm², or more specifically, may be 14 kgf/cm²to 21 kgf/cm², or more specifically, may be 15 kgf/cm² to 20 kgf/cm².

When the reference value is less than the numerical range described above, the fragile portion 130 may be easily broken or disconnected even by a weak external force, thereby degrading mechanical strength of the battery cell 10 itself. When the reference value exceeds the numerical range described above, the fragile portion 130 may not be easily broken or disconnected despite an increase in internal pressure, and as a result, it may be difficult to induce electrical disconnection between the first body portion 110 and the second body portion 120, making it impossible to prevent explosion through preemptive interruption upon internal ignition, thereby making it difficult to achieve the safety improvement effect of the battery cell 10 according to the present disclosure.

Meanwhile, referring again to FIG. 6, in one embodiment, the first body portion 110 and the second body portion 120 may be completely separated as the fragile portion 130 is disconnected.

As illustrated in FIG. 6, an example is shown in which the first body portion 110 and the second body portion 120 are completely separated due to disconnection of the fragile portion 130 as described above. As the fragile portion 130 is disconnected due to internal pressure generation as described above, the second body portion 120 that contacts the current collecting member 400, specifically, the second body portion 120 welded to the current collecting member 400, may remain in a contacted (coupled) state with the current collecting member 400 while being separated from the first body portion 110. Through such an embodiment, when an internal pressure equal to or higher than a desired reference value is generated, the first body portion 110 and the second body portion 120 of the terminal 100 may be completely separated, so that a current path connecting an inside and an outside of the battery cell 10 may be preemptively interrupted, thereby preventing additional events from occurring due to the progress of ignition.

FIG. 7 is a diagram illustrating a view of the terminal in a +Z direction of FIGS. 1 to 4 according to another embodiment of the present disclosure.

Referring to FIG. 7, in one embodiment, the terminal 100 may further include a connecting portion 140 that connects the first body portion 110 and the second body portion 120 and has a thickness thicker than a thickness of the fragile portion 130.

In such an embodiment, in addition to the fragile portion 130 as a configuration connecting the first body portion 110 and the second body portion 120, a connecting portion 140 may further be included in the terminal 100.

As described above, the fragile portion 130 has a thickness thinner than a thickness of the second body portion 120, and thus may be configured to be vulnerable to any physical external force. Specifically, the fragile portion 130 may connect the first body portion 110 and the second body portion 120, and may be configured such that when any external force is applied, it is broken so that the first body portion 110 and the second body portion 120 may be easily separated.

The connecting portion 140 may have a thickness thicker than a thickness of the fragile portion 130. In a specific embodiment, a thickness of the connecting portion 140 may be substantially the same as a thickness of the second body portion 120. In a specific embodiment, an average thickness of the connecting portion 140 may be configured to be substantially the same as an average thickness of the second body portion 120. Here, the average thickness may be applied as described above with reference to FIGS. 2 to 6.

In such an embodiment, unlike the fragile portion 130, the connecting portion 140 may be configured to be substantially not vulnerable to any physical external force. In one embodiment, the connecting portion 140 may connect the first body portion 110 and the second body portion 120 and may be configured not to be substantially broken even when any external force is applied.

Meanwhile, a shape observed at a lower portion of the terminal 100 according to such an embodiment, particularly in the third region 103, is illustrated in FIG. 7. In such an embodiment, the second body portion 120 may be surrounded by the first body portion 110 in the third region 103, but at least a portion of the first body portion 110 and the second body portion 120 may be connected by the fragile portion 130, and a remaining portion may be connected by the connecting portion 140.

In such an embodiment, the fragile portion 130 may not have a closed-curve cross-section. In such an embodiment, the first body portion 110 may surround a portion of the second body portion 120 via the fragile portion 130, and may surround a remaining portion of the second body portion 120 via the connecting portion 140.

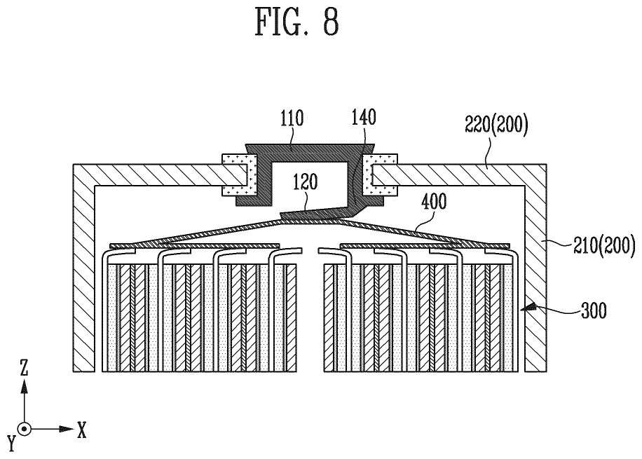

FIG. 8 is a diagram illustrating an example of a state in which a first body portion and a second body portion of the terminal are partially separated according to an embodiment of the present disclosure.

Referring to FIG. 8 together with the drawings described above, in one embodiment, according to the embodiment as described above, when an internal pressure equal to or higher than the reference value is generated inside the case 200, the fragile portion 130 may be disconnected, and as the fragile portion 130 is disconnected, the first body portion 110 and the second body portion 120 may be partially disconnected.

That is, regarding the configuration in which the fragile portion 130 is disconnected when an internal pressure equal to or higher than the reference value is generated inside the case 200, it is as described above with reference to FIGS. 5 and 6. Meanwhile, even when an internal pressure equal to or higher than the reference value is generated inside the case 200, the connecting portion 140 may not be disconnected. Since the description regarding internal pressure generation and the external force acting on the terminal 100 due to the internal pressure is the same as previously described with reference to FIGS. 5 and 6, redundant explanation will be omitted below.

In one embodiment, the reference value may be 12 kgf/cm² to 23 kgf/cm². In a specific embodiment, the reference value may be 13 kgf/cm² to 22 kgf/cm², or more specifically, may be 14 kgf/cm² to 21 kgf/cm², or more specifically, may be 15 kgf/cm² to 20 kgf/cm².

When the reference value is less than the numerical range described above, the fragile portion 130 may be easily broken or disconnected even by a weak external force, thereby degrading mechanical strength of the battery cell 10 itself. When the reference value exceeds the numerical range described above, the fragile portion 130 may not be easily broken or disconnected despite an increase in internal pressure, making it difficult to induce an increase in resistance at the connecting portion 140 due to disconnection. As a result, it becomes impossible to prevent explosion through preemptive interruption upon internal ignition, making it difficult to achieve the safety improvement effect of the battery cell 10 according to the present disclosure.

Meanwhile, referring again to FIG. 8, in one embodiment, the first body portion 110 and the second body portion 120 may be partially separated as the fragile portion 130 is disconnected.

As illustrated in FIG. 8, an example in which the first body portion 110 and the second body portion 120 are partially separated due to disconnection of the fragile portion 130, as described above, is shown. That is, as illustrated in FIG. 8, when the fragile portion 130 is disconnected as described above, a portion that had been connected by the fragile portion 130 is open-circuited and the first body portion 110 and the second body portion 120 are separated at that portion, while a portion that had been connected by the connecting portion 140 remains maintained, whereby an example in which the first body portion 110 and the second body portion 120 are partially separated is illustrated.

As the fragile portion 130 is disconnected due to internal pressure generation as described above, the second body portion 120 that contacts the current collecting member 400, specifically, the second body portion 120 welded to the current collecting member 400, remains in a contacted (coupled) state with the current collecting member 400, while at the same time remaining connected to the first body portion 110 via the connecting portion 140, whereby the second body portion 120 may be partially separated from the first body portion 110.

Through such an embodiment, when an internal pressure equal to or higher than a desired reference value is generated, the first body portion 110 and the second body portion 120 of the terminal 100 may be partially separated such that they are connected only via the connecting portion 140. As a result, a current path connecting the inside and the outside of the battery cell 10 is limited to only the connecting portion 140, which corresponds to only a part of the original path. Therefore, resistance due to current passing through the reduced path may increase rapidly, thereby preventing additional events from occurring due to the progress of ignition.

Referring again to FIG. 2, in one embodiment, the electrode assembly 300 may include a first electrode 310 and a second electrode 320, and the first electrode 310 may include a first coating portion, which is a region coated with a first electrode active material, and a first non-coating portion 311, which is a region other than the first coating portion, and the current collecting member 400 may contact the first non-coating portion 311.

As described above, the electrode assembly 300 may be received in the receiving space 280 of the case 200. Meanwhile, the electrode assembly 300 may be received in the receiving space 280 of the case 200 in a wound form.

In one embodiment, the electrode assembly 300 may include the first electrode 310 and the second electrode 320. The first electrode 310 and the second electrode 320 may each be either a positive electrode or a negative electrode.

In one embodiment, the first electrode 310 may be a positive electrode. In such an embodiment, the second electrode 320 may be a negative electrode.

In one embodiment, when the first electrode 310 is the positive electrode, the first electrode 310 may include a positive electrode current collector and a positive electrode active material. The positive electrode current collector may include a known conductive material within a range that does not cause a chemical reaction in a lithium secondary battery. For example, the positive electrode current collector may include any one of stainless steel, nickel (Ni), aluminum (Al), titanium (Ti), copper (Cu), and alloys thereof, and may be provided in various forms such as a film, a sheet, or a foil. The positive electrode active material may include a material in which lithium ions can be inserted and extracted. The positive electrode active material may be, for example, a lithium metal oxide.

Meanwhile, when the second electrode 320 is the negative electrode, the second electrode 320 may include a negative electrode current collector and a negative electrode active material. The negative electrode current collector may include a known conductive material within a range that does not cause a chemical reaction in a lithium secondary battery. For example, the negative electrode current collector may include any one of stainless steel, nickel (Ni), aluminum (Al), titanium (Ti), copper (Cu), and alloys thereof, and may be provided in various forms such as a film, a sheet, or a foil. The negative electrode active material may include a material in which lithium ions can be inserted and extracted. The negative electrode active material may include, for example, carbon-based materials such as crystalline carbon, amorphous carbon, carbon composites, or carbon fibers, lithium alloys, silicon (Si), tin (Sn), or any combination thereof.

Contrary to the foregoing, the first electrode 310 may be a negative electrode as needed, and accordingly, the second electrode 320 may be a positive electrode.

In one embodiment, the electrode assembly 300 may further include a separator. In such an embodiment, the electrode assembly 300 may be formed such that the first electrode 310, the separator, and the second electrode 320 are sequentially stacked, and the stacked body may be received in the receiving space 280 in a form wound around a winding axis.

In an exemplary embodiment, the electrode assembly 300 may be wound in a roll form, and such a roll-shaped stacked body may be referred to as a “jelly roll.” The roll form may have a circular cross-section; however, it is not necessarily limited thereto and may have an elliptical or oblong cross-section, or various other shapes such as a rectangle including arbitrary curved portions.

Meanwhile, the wound electrode assembly 300 may have a hollow portion formed at its core along the winding axis. In an exemplary embodiment, the hollow portion may be formed in a cylindrical shape. The hollow portion may function as a passage through which an electrolyte is injected during an electrolyte injection process in manufacturing the battery cell 10. Based on the illustration of FIG. 2, for example, the hollow portion may be formed along a path connecting the center of the cap plate (not shown) and the center of the closed end portion 220.

According to an exemplary embodiment, the separator may be included to prevent an electrical short-circuit between the first electrode 310 and the second electrode 320 and to allow ionic conduction. The separator may include, for example, a porous polymer film or a porous nonwoven fabric.

According to an exemplary embodiment, the electrode assembly 300 may be immersed in an electrolyte within the case 200. The electrolyte may be a non-aqueous electrolyte. The electrolyte may include a lithium salt and an organic solvent, and may further include an additive as needed.

In another embodiment, the battery cell 10 may be an all-solid-state battery. In such an embodiment, the electrode assembly 300 may not necessarily be immersed in an electrolyte. Meanwhile, in such an embodiment, a solid electrolyte layer may be formed instead of the separator, or together with the separator, to prevent electrical short-circuit between the first electrode 310 and the second electrode 320 and to allow ionic conduction.

Referring again to FIG. 2, in one embodiment, the first electrode 310 may include a first coated portion in which a first electrode active material is coated, and a first uncoated portion 311 which is a region other than the first coated portion.

In one embodiment, the first electrode 310 may include a current collector and an active material (layer) coated on at least a portion of the current collector, as described above. In the first electrode 310, the region of the current collector on which the active material is coated, together with the active material coated thereon, may be referred to as the first coated portion. Meanwhile, a region other than the first coated portion may be referred to as the first uncoated portion 311. In an exemplary embodiment, the first uncoated portion 311 may be defined as a region in which the active material is not coated and both surfaces of the current collector are exposed to the outside. Meanwhile, the first uncoated portion 311 may be formed along one edge of the current collector of the first electrode 310 outside the first coated portion.

According to an exemplary embodiment, the first uncoated portion 311 may be formed such that it is drawn out in a direction in which the terminal 100 is located. Based on the illustration of FIG. 2, for example, the first uncoated portion 311 may be formed such that it is drawn out in the +Z direction.

According to an exemplary embodiment, the first uncoated portion 311 may include a flag structure in which a plurality of cutting portions are formed at a predetermined interval and depth at an outer end thereof, and at least a portion of a region between each adjacent pair of cutting portions is folded in a predetermined direction. In a specific embodiment, each of the flag structures may be folded in a direction toward the winding axis, as illustrated in FIG. 2.

In one embodiment, the current collecting member 400 may contact the first uncoated portion 311.

In a specific embodiment, the current collecting member 400 may be welded to the first uncoated portion 311.

As described above, the current collecting member 400 may be a current collecting plate formed in a plate shape having a predetermined thickness. In such an embodiment, the current collecting plate may be welded to the flag structure of the first uncoated portion 311 described above.

Meanwhile, as described above, the current collecting member 400 may contact the second body portion 120 of the terminal 100. Therefore, in such an embodiment, when the current collecting member 400 is a current collecting plate formed in a plate shape as described above, one surface of the current collecting plate may contact the second body portion 120, and the other surface thereof may contact the first uncoated portion 311 (specifically, the flags of the first uncoated portion 311).

Through such an embodiment, electrical energy produced from the electrode assembly 300 may pass through the uncoated portion, be transferred to the terminal 100 via the current collecting member 400, and be supplied to the outside through the terminal 100. Conversely, electrical energy supplied from the outside may enter the accommodation space 280 of the battery cell 10 through the terminal 100, be transferred to the electrode assembly 300 via the current collecting member 400 after passing through the uncoated portion, and be supplied to the electrode assembly 300.

The terminal 100 according to one embodiment of the present disclosure, as described above, may have its weak portion 130 severed when an internal pressure is generated inside the battery cell 10, such that the first body portion 110 and the second body portion 120 may be completely or partially separated. Thus, the path of electrical energy moving between the inside and outside of the battery cell 10 may be blocked by the complete separation of the terminal 100, or may be blocked due to an increase in resistance at the connection portion 140 caused by partial separation of the terminal 100.

For configurations other than the above-described embodiments, elements that may commonly be used in the field of secondary batteries may be applied without limitation.

In one embodiment, when the battery cell 10 is a cylindrical can-type battery cell 10 having the cylindrical shape illustrated in FIG. 1, its form factor may be a cylindrical cell such as 18650, 21700, 26650, 32700, 32140, 46110, 4680, 4695, 48110, 4875, or 4880. In a specific embodiment, the form factor may be 46110, 4680, 4695, 48110, 4875, or 4880. In a more specific embodiment, the form factor of the battery cell 10 may be 4680, having a diameter of approximately 46 mm and a height of approximately 80 mm, but is not necessarily limited thereto.

The battery cell 10 according to one embodiment of the present disclosure may be used not only as a battery cell serving as a power source for small-sized devices, but also preferably as a unit cell of a battery module and/or a battery pack of medium-or large-sized devices including a plurality of battery cells. Examples of the small-sized devices include, for example, mobile phones, laptop computers, and cameras, but are not limited thereto. Examples of the medium-or large-sized devices include electric vehicles, hybrid electric vehicles, plug-in hybrid electric vehicles, and power storage systems, but are not limited thereto.

The above description is merely an example applying the principles of the present disclosure, and other configurations may be further included within the scope of the present disclosure without departing from the spirit thereof.

What is claimed is:

1. A battery cell comprising:
a case having a receiving space therein;
an electrode assembly received in the receiving space;
a current collecting member received in the receiving space and electrically connected to the electrode assembly;
a through-hole formed at at least a portion of the case; and
a terminal penetrating the case through the through-hole,
wherein the terminal comprises a first body portion of which at least a portion is exposed to an outside of the case, a second body portion of which at least a portion is in contact with at least a portion of the current collecting member, and a fragile portion that connects the first body portion and the second body portion and has a thickness that is less than the thickness of the second body portion.

2. The battery cell according to claim 1, wherein the case comprises at least one of aluminum and iron.

3. The battery cell according to claim 1, wherein the current collecting member is a current collecting plate.

4. The battery cell according to claim 1, wherein the terminal comprises a first region located at the through-hole, a second region located outside the case, and a third region located in the receiving space, and an average cross-sectional area of the second region is greater than a cross-sectional area of the through-hole, and an average cross-sectional area of the third region is greater than the cross-sectional area of the through-hole.

5. The battery cell according to claim 4, wherein the second body portion is located at the third region, and an average cross-sectional area of the second body portion is smaller than a cross-sectional area of the through-hole.

6. The battery cell according to claim 1, wherein the second body portion is welded to the current collecting member.

7. The battery cell according to claim 1, wherein an average thickness of the fragile portion is 5% to 50% of an average thickness of the second body portion.

8. The battery cell according to claim 1, wherein when an internal pressure equal to or greater than a reference value is generated inside the case, the fragile portion is disconnected.

9. The battery cell according to claim 8, wherein the reference value is 12 kgf/cm² to 23 kgf/cm².

10. The battery cell according to claim 8, wherein the first body portion and the second body portion are completely separated as the fragile portion is disconnected.

11. The battery cell according to claim 1, wherein the terminal further comprises a connection portion connecting the first body portion and the second body portion and having a thickness thicker than a thickness of the fragile portion.

12. The battery cell according to claim 11, wherein when an internal pressure equal to or greater than a reference value is generated inside the case, the fragile portion is disconnected, and the first body portion and the second body portion are partially separated as the fragile portion is disconnected.

13. The battery cell according to claim 12, wherein the reference value is 12 kgf/cm² to 23 kgf/cm².

14. The battery cell according to claim 1,
wherein the electrode assembly comprises a first electrode and a second electrode,
wherein the first electrode comprises a first coating portion which is a region coated with a first electrode active material and a first non-coating portion which is a region other than the first coating portion,
and wherein the current collecting member is in contact with the first non-coating portion.

15. The battery cell according to claim 14, wherein the first electrode is a positive electrode.
